(19) United States
(12) Patent Application Publication
(10) Pub. No.: US 2012/0278429 A1
(43) Pub. Date: Nov. 1, 2012

(54) CLUSTER SYSTEM, SYNCHRONIZATION CONTROLLING METHOD, SERVER, AND SYNCHRONIZATION CONTROLLING PROGRAM

(75) Inventors: Koichi Miura, Kawasaki (JP); Kiyoshi Nakanouchi, Kawasaki (JP); Daisuke Shimabayashi, Kawasaki (JP)

(73) Assignee: FUJITSU LIMITED, Kawasaki-shi (JP)

(21) Appl. No.: 13/364,527

(22) Filed: Feb. 2, 2012

(30) Foreign Application Priority Data
Apr. 28, 2011 (JP) 2011-102109

(51) Int. Cl. G06F 15/16

(52) U.S. Cl. 709/217

(57) ABSTRACT

A cluster system includes an active server and an additional server, and each of the servers includes a database (DB) storing therein client data, information indicating the location of the client data, and information indicating a record status as a record. The active server transmits a record included in the DB as first information as well as type information indicating the first information to the additional server, and when the record is updated, transmits the record thus updated as second information as well as type information indicating the second information to the additional server. The additional server receives the first information or the second information from the active server. The additional server then generates a record for the information thus received in the DB depending on the received type information and the status of the record stored in the DB and identified by the received information.

### CROSS-REFERENCE TO RELATED APPLICATION

This application is based upon and claims the benefit of priority of the prior Japanese Patent Application No. 2011-102109, filed on Apr. 28, 2011, the entire contents of which are incorporated herein by reference.

### FIELD

The embodiments discussed herein are directed to a cluster system, a synchronization controlling method, a server, and a synchronization controlling program.

### BACKGROUND

In a conventional system for providing a service to a client and the like, in case of any failure of the active server providing the service, for example, a standby server is used to continue providing the service. Known as an example of such a system is a cluster system, in which data is mirrored between an active server and a standby server each having a disk (hereinafter, referred to as a mirroring cluster), without utilizing a shared disk that is shared among these servers.

For example, in a mirroring cluster, when a standby server is activated as a new active server, a new standby server (hereinafter, referred to as an additional server) is added to the cluster. At this time, data maintained on the new active server and data maintained on the additional server need to be synchronized.

Known as a technique for synchronizing such data is to back up the data on the active server to an external recording medium, and to restore the data on the additional server. Techniques such as replication and duplication are also known. However, when these techniques are used, applications are stopped until the data is synchronized. Therefore, it is not possible to apply these techniques to a system in which no interruption of the service is permitted for 24 hours a day.

Known as a technique for synchronizing the data without stopping the applications is a technique in which data is synchronized in two phases: a synchronization phase for synchronizing the data and an updating phase for updating the data that is updated during the synchronization phase.

During the synchronization phase, data is transmitted from the active server to the additional server storing therein no data, for example. Data updated during the synchronization phase is simply stored in the active server or in the additional server, without such data being applied to any of these servers. Once the synchronization phase is completed, the server storing therein the update data applies the update data to the local storage, and transmits the update data to the other server, and ends the synchronization of the data.

As another technique, known is a database reorganization technique that enables a database to be migrated independently of the data structure of the database and practically without stopping online services. In such a database reorganization technique, if there is a data updating access specifying the physical location of a data item that has already been copied during the process of copying data, the data updating process is executed in the active database and the backup database. In such a database reorganization technique, once the copying is completed, the destination of an online message is switched to backup database accessing means. Related-art examples are described in Japanese Laid-open Patent Publication No. 2009-199197, Japanese Laid-open Patent Publication No. 2005-327015, Japanese Laid-open Patent Publication No. 2009-157785, Japanese Laid-open Patent Publication No. 2005-316624, and Japanese Laid-open Patent Publication No. 2007-041888.

However, in the conventional technologies, it takes time for a server that is newly added to the cluster system to achieve synchronization of the data.

For example, explained below are examples in which the two-phase data synchronization technique and the database reorganization technique are applied to a large scale system such as those for a bank and a security exchange. More specifically, explained below is an example where an additional server is added to a cluster system storing therein a large number of managed data items, or a large scale cluster system including a plurality of standby servers.

If the two-phase technique is applied to a cluster system with a large number of managed data items, it will take time just to transmit all of the data from the active server to the additional server and to achieve synchronization. Furthermore, in this technique, once the managed data is synchronized, the data that is updated during the synchronization process is further synchronized. Because not only data items managed by the active server but also data items updated during the data transmission are synchronized, it will take time to achieve synchronization in a system that manages a vast number of data items or that updates data frequently.

Furthermore, in the example of the reorganization technology, the active server writes a data item to be synchronized to a database maintained on each of the standby servers and to a database maintained on the additional server. The active server then commits the writing process upon completing writing the data to each of the databases, and starts writing the next piece of data. In other words, in the reorganization technology, to achieve data synchronization, the active server has to check the progress of data copying, write data, commit the writing, and so on for every piece of data items. Accordingly, when a large number of standby servers are used, the processing load on the active server increases. In addition, because the data writing process is executed for each piece of data items, in other words, the synchronizing process is executed for each piece of data items after committing every transaction, the data writing process takes a long time. Thus, in these examples, it takes time to achieve synchronization of the additional server.

### SUMMARY

According to an aspect of an embodiment of the invention, a cluster system includes a first server and a second server, wherein each of the first server and the second server includes a storage unit storing therein client data, information indicating a location of the client data, and information indicating a record status as a record, the first server further comprises a transmitting unit that transmits a record stored in the storage unit as first information as well as type information indicating the first information to the second server, and, when the record is updated, transmits the record thus updated as second information as well as type information indicating the second information to the second server, and the second server further comprises a receiving unit that receives the first information or the second information from the first server, and a generating unit that generates a record for the information thus received in the storage unit depending on the type information received by the receiving unit and a status of the record stored in the storage unit and identified by the information thus received.

According to another aspect of an embodiment of the invention, a server includes a receiving unit that receives first information that is information of a record in a storage unit included in a first server as a source server and storing therein client data, information indicating a location of the client data, and a record status as a record, as well as type information indicating the first information from the source server, or, when the record is updated, receives second information that is information of the record thus updated and type information indicating the second information; and a generating unit that generates a record for the information thus received in a local storage unit included in the server depending on the type information received by the receiving unit, and a status of the record in the storage unit and identified by the information thus received.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic illustrating an example of the overall configuration of a cluster system according to a first embodiment of the present invention;

FIG. 2 is a functional block diagram illustrating a configuration of the active server according to a second embodiment of the present invention;

FIG. 3 is a schematic illustrating an example of the data structure of a record included in a storage unit;

FIG. 4 is a schematic illustrating an example of the data structure of a log transmitted by an active server;

FIG. 5 is a functional block diagram illustrating a configuration of a standby server according to the second embodiment;

FIG. 6 is a schematic illustrating an example of criteria allowing a standby server to determine whether an update log and a synchronization log may be applied;

FIG. 7 is a functional block diagram illustrating a configuration of an additional server according to the second embodiment;

FIG. 8 is a schematic illustrating an example of criteria allowing the additional server to determine whether an update log and a synchronization log may be applied;

FIG. 9 is a flowchart illustrating an update log transmitting process performed by the active server according to the second embodiment;

FIG. 10 is a flowchart illustrating a synchronization log transmitting process performed by the active server according to the second embodiment;

FIG. 11 is a flowchart illustrating a process performed by the standby server according to the second embodiment;

FIG. 12 is a flowchart illustrating a process performed by the additional server according to the second embodiment; and

FIG. 13 is a schematic illustrating an example of a hardware configuration of a computer executing a synchronization controlling program.

### DESCRIPTION OF EMBODIMENT(S)

Embodiments of a cluster system, a synchronization controlling method, a server, and a synchronization controlling program disclosed in the present application will now be explained in detail with reference to drawings. The embodiments are not intended to limit the scope of the present invention in any way.

### [a] First Embodiment

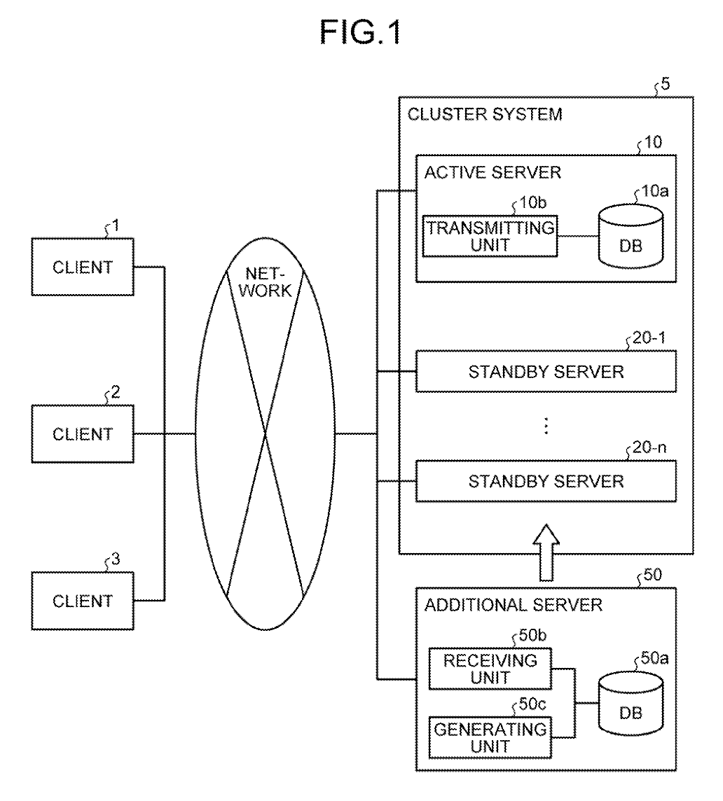

FIG. 1 is a schematic illustrating an example of the overall configuration of a cluster system according to a first embodiment of the present invention. As illustrated in FIG. 1, the system includes a client 1, a client 2, a client 3, a cluster system 5, and an additional server 50 connected communicatively over a network such as the Internet.

The client 1, the client 2, and the client 3 are computer devices used by end users, and executes writing of data to or reading of data from an active server 10 included in the cluster system 5. In the example explained herein, each of the clients is a computer device belonging to an end user. However, the configuration is not limited thereto, and the computer device may be a server such as a Web server or an application server, for example.

The cluster system 5 includes the active server 10 and a plurality of standby servers 20-1 to 20-n (n: natural number), and is a system realizing a non-stop operation and storing therein data of each of the clients. In the cluster system 5, the database maintained on the active server 10 is mirrored to the database maintained on each of the standby servers. For example, when the data is updated, the active server 10 transmits the update data to each of the standby servers, and each of the standby servers updates the local database using the update data.

In the cluster system 5, when a hardware failure of the active server 10 or a network interruption occurs, the active server 10 is automatically switched to the standby server to continue providing services to the clients. For example, when the active server 10 fails, the standby server 20-1 is promoted to an active server. As methods for detecting failures and promoting a standby server to an active server, generally-available software and the like used in a cluster system may be used.

In the first embodiment, each of the servers included in the cluster system 5 is explained to be a database server that manages client data. However, the present invention is not limited thereto, and the server may be a Web server or an application server executing database synchronization.

The active server 10 is a database server including a database (DB) 10a storing therein client data, information indicating the location of such data, and information indicating a record status as a record, and receiving various requests from each of the clients and making responses to the requests. For example, when a data retrieving request is received from the client 1, the active server 10 retrieves corresponding data from the DB 10a, and responds to the client 1 with the result of retrieval. When a data updating request is received from the client 1, the active server 10 retrieves the corresponding data from the DB 10a, updates the data, and responds the client 1 with the result of updating.

The active server 10 includes a transmitting unit 10b, and executes synchronization of databases when the additional server 50 that is a new server is added to the cluster system 5. More specifically, the transmitting unit 10b transmits a record in the DB 10a as first information and type information indicating the first information to the additional server 50, and, when there is an update to a record, transmits second information that is the record being updated as well as type information indicating the second information to the additional server 50.

Each of the standby servers 20-1 to 20-n is a database server functioning as a standby system of the active server 10. Each of the standby servers 20-1 to 20-n has a database that is synchronized with the active server 10. Orders at which the standby servers are promoted to the active server and the like may be specified by a user optionally. To improve the reliability of the cluster system 5, it is preferable for the cluster system 5 to include two or more standby servers.

The additional server 50 is a server that is newly added to the cluster system 5, and includes a DB 50a, a receiving unit 50b, and a generating unit 50c. When the additional server 50 is added to the cluster system 5, the additional server 50 executes a database synchronizing process.

The DB 50a is an empty database at the time the additional server 50 is added to the cluster system 5, and comes to store therein data synchronized with the DB 10a in the active server 10 after the synchronizing process is executed. The receiving unit 50b receives the first information or the second information from the active server 10. The generating unit 50c either discards the information thus received or applies the information thus received to the DB 50a depending on the type information received by the receiving unit 50b and the status of the record in the DB 50a identified by the received information.

In the manner described above, to synchronize the DB in the additional server 50 that is newly added to the cluster system 5, the active server 10 transmits the first information that is information of the DB and the second information for updating the information of the DB in parallel without serialization. The additional server 50 then determines if such information may be applied based on a log received, and processes the information. As a result, the time to achieve data synchronization for the standby server newly added to the system can be reduced.

### [b] Second Embodiment

An exemplary configuration of each of the devices included in the cluster system 5 illustrated in FIG. 1 and a process executed by each of the devices will now be explained. Because the standby servers 20-1 to 20-n have the same configuration, the standby servers 20-1 to 20-n will be explained as a standby server 20.

Configuration of Active Server

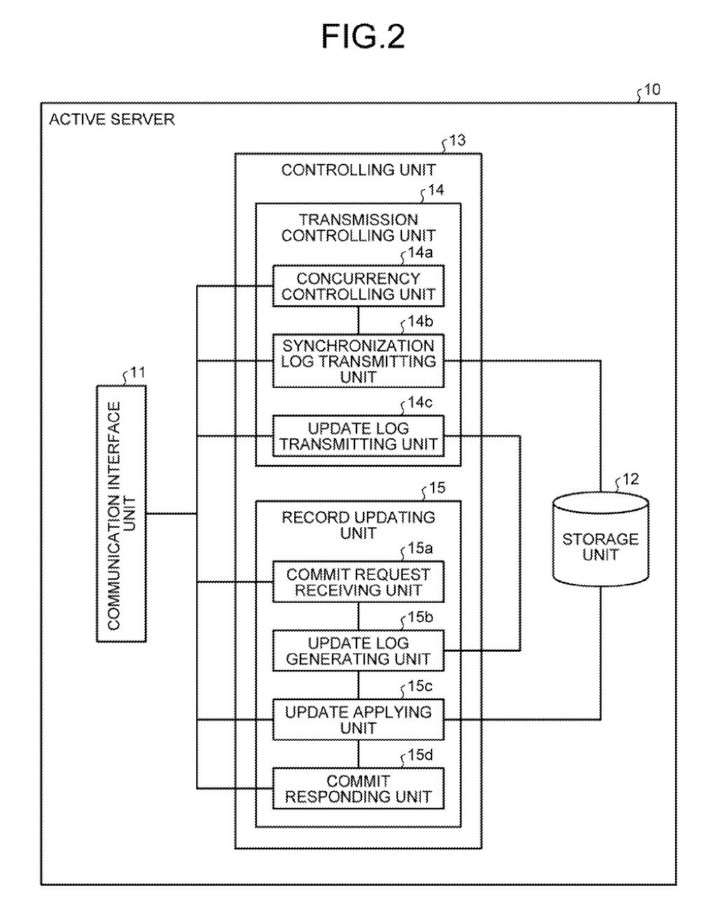

FIG. 2 is a functional block diagram illustrating a configuration of the active server according to the second embodiment. As illustrated in FIG. 2, the active server 10 includes a communication interface unit 11, a storage unit 12, and a controlling unit 13. Processing units included in the active server 10 are not limited to those illustrated in FIG. 2, and the active server 10 may also include a displaying unit such as a display and an input unit such as a keyboard.

The communication interface unit 11 is a communication module such as a network interface card, and controls communications with other devices. For example, the communication interface unit 11 receives a request such as a data retrieving request or a data updating request from each of the clients, outputs the request to the controlling unit 13, and transmits a response received from the controlling unit 13 to the client. The communication interface unit 11 transmits a synchronization log or an update log to each of the standby serves and the additional server 50, and receives a response from each of the servers.

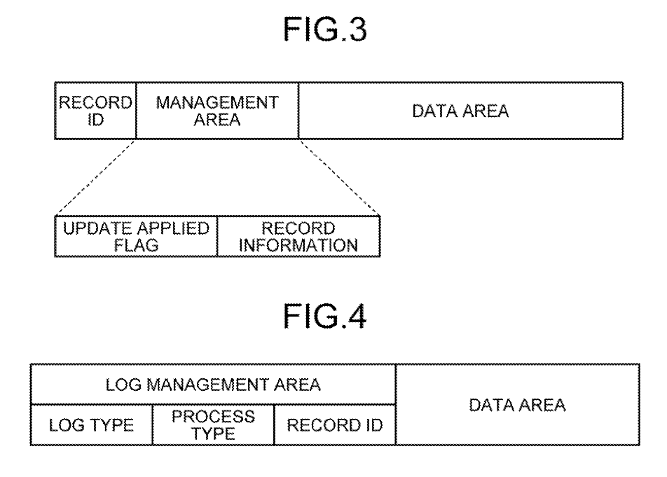

The storage unit 12 is a storage device having at least one semiconductor memory element or hard disk storing therein a database of client data. FIG. 3 is a schematic illustrating an example of the data structure of a record stored in the database included in the storage unit 12. As illustrated in FIG. 3, the database included in the storage unit 12 is structured as a record having “record ID”, “management area”, and “data area”. The “record ID” is an identifier for uniquely identifying a record in the database included in the storage unit 12, and is information such as location information or an address.

The “management area” is management information including an update applied flag and record information indicating the status of the record. The “update applied flag” is information indicating whether an update log has been applied, in other words, whether any operation has been made to the record based on an update log. The “management area”, for example, stores therein “ON” when the update log has been applied, and stores therein “OFF” when the update log has not been applied. The “record information” is information indicating the presence of a record that is user data, and stores therein “record present” when the user data is present, and “record not present” when the user data is not present, for example. The data area is a data area for storing therein user data.

The controlling unit 13 is an electrical circuit, such as an integrated circuit e.g., field-programmable gate array (FPGA), or a central processing unit (CPU), including a transmission controlling unit 14 and a record updating unit 15, and executing the database synchronizing process using these units. The controlling unit 13 includes software for realizing clustering and hardware for realizing clustering. The controlling unit 13 also executes a process corresponding to each request received from the client. For example, when a data reading request is received from a client, the controlling unit 13 obtains a corresponding record from the database maintained on the storage unit 12 using the record ID, the address, and the like included in the reading request, and makes a response to the client.

The transmission controlling unit 14 is a processing unit including a concurrency controlling unit 14a, a synchronization log transmitting unit 14b, and an update log transmitting unit 14c, and executing the database synchronizing process using these units. When an instruction for starting the synchronizing process is received from an administrator over the network, or when the additional server 50 is detected to be added to the cluster system 5, the transmission controlling unit 14 starts the synchronizing process.

The concurrency controlling unit 14a is a processing unit that enforces mutual exclusion between a transmission of a synchronization log and an updating process when there is an attempt to update or to add a record at the timing the synchronizing process is initiated. For example, assuming that the record updating unit 15 attempts to update a record at the timing the synchronization log transmitting unit 14b starts reading the record from the database in the storage unit 12 to generate a synchronization log, the concurrency controlling unit 14a enforces mutual exclusion by temporarily interrupting the process of the synchronization log transmitting unit 14b.

When the record updating unit 15 completes updating the record, the concurrency controlling unit 14a restarts the process of the synchronization log transmitting unit 14b, and releases a lock for concurrency controlling. After the record updating process is completed, the concurrency controlling unit 14a refers to the database in the storage unit 12 that is to be synchronized and counts the number of records. The concurrency controlling unit 14a then may determine the number of records thus counted as the number of records to be synchronized, and may notify the number of records thus identified to the synchronization log transmitting unit 14b.

Once the transmission controlling unit 14 starts the synchronizing process and the concurrency controlling unit 14a releases the lock for concurrency controlling, the synchronization log transmitting unit 14b transmits a synchronization log that is information about a record in the database included in the storage unit 12 to each of the standby servers and the additional server 50. For example, the synchronization log transmitting unit 14b reads a record located at the head of the database to be synchronized. The synchronization log transmitting unit 14b then generates a synchronization log by extracting user data included in the record thus read. The synchronization log transmitting unit 14b then transmits the synchronization log thus generated to each of the standby servers and the additional server 50 over multicast.

After transmitting the synchronization log, if a response of receiving the synchronization log is received from each of the destination servers, the synchronization log transmitting unit 14b reads the next record, generates a synchronization log, and transmits the synchronization log thus generated to each of the standby servers and the additional server 50 over multicast. In this manner, every time a response corresponding to the transmitted synchronization log is received, the synchronization log transmitting unit 14b generates a synchronization log for the next record, and transmits the synchronization log. The synchronization log transmitting unit 14b repeats transmitting the synchronization log until the last record included in the database to be synchronized is completed, or repeats transmitting the synchronization log until the number of records notified by the concurrency controlling unit 14a is reached.

The update log transmitting unit 14c generates, when there is an update in the database included in the storage unit 12, an update log based on the information about the record thus updated, and transmits the update log to each of the standby servers and the additional server 50. For example, when an update log is generated by an update log generating unit 15b, the update log transmitting unit 14c transmits the update log thus generated to each of the standby servers and the additional server 50 over multicast.

Information included in a log transmitted by the synchronization log transmitting unit 14b or the update log transmitting unit 14c will now be explained. FIG. 4 is a schematic illustrating an example of the data structure of the log transmitted by the active server. As illustrated in FIG. 4, the log includes a “log management area” and a “data area”. The “log management area” is information indicating management information of the log, and includes “log type”, “process type”, and “record ID”. Among those three, the “log type” represents information indicating whether the log is a synchronization log or an update log, and stores therein, for example, “synchronization log” or “update log”. The “process type” indicates a specific process executed by the log, and stores therein, for example, “update”, “delete”, or “add”. The “record ID” is an identifier that uniquely identifies the record, in the same manner as that illustrated in FIG. 3. The “data area” stores therein user data in the same manner as the data area illustrated in FIG. 3.

For example, the synchronization log transmitting unit 14b reads user data from the data area in a record A that is read from the database. The synchronization log transmitting unit 14b then generates a “log management area” with the log type specified as “synchronization log”, the process type specified as “add”, and the record ID specified as “record A”. The synchronization log transmitting unit 14b then generates a synchronization log by appending a “data area” storing therein the user data thus read to the “log management area” thus generated. The synchronization log transmitting unit 14b then transmits the synchronization log thus generated. Generation of the update log will be explained later.

Referring back to FIG. 2, the record updating unit 15 is a processing unit including a commit request receiving unit 15a, the update log generating unit 15b, an update applying unit 15c, and a commit responding unit 15d, and by using these units, updating a record included in the database stored in the storage unit 12 and synchronizing the data thus updated. By means of this record updating unit 15, each of the servers included in the cluster system 5 is enabled to synchronize databases to achieve mirroring.

The commit request receiving unit 15a is a processing unit that receives a request for committing a transaction from a client while an application on the client is executing a transaction. For example, the commit request receiving unit 15a receives updating of a record, such as addition, update, or deletion of a record, as a commit request, and outputs the information thus received to the update log generating unit 15b.

The update log generating unit 15b is a processing unit that generates an update log based on the commit request received from the commit request receiving unit 15a, and outputs the update log to the update log transmitting unit 14c and the update applying unit 15c. Generation of an update log will now be explained using an example of a commit request specifying addition, update, or deletion of a record.

For example, it is assumed that a record ID=record B specified in the commit request is not found in the database stored in the storage unit 12, or user data corresponding to the record B is not present in the database. In such a situation, when the transaction for adding the record B is committed, the update log generating unit 15b generates a “log management area” having the log type specified as “update log”, the process type specified as “add”, and the record ID specified as “record B” for the record B. The update log generating unit 15b then appends the “data area” storing therein user data of the record B to the “log management area” thus generated, to generate an update log.

It is now assumed that user data corresponding to a record ID=record C specified in the commit request is present in the database in the storage unit 12 and the commit request contains user data. In this situation, when the transaction for updating the record C is committed, the update log generating unit 15b generates a “log management area” having the log type specified as “update log”, the process type specified as “update”, and the record ID specified as “record C” for the record C. The update log generating unit 15b then appends a “data area” storing therein the user data for the record C to the “log management area” thus generated, to generate an update log.

It is then assumed that user data corresponding to a record ID=record D specified in the commit request is present in the database in the storage unit 12 and the commit request does not contain any user data. In this situation, when the transaction for deleting the record D is committed, the update log generating unit 15b generates a “log management area” having the log type specified as “update log”, the process type specified as “delete”, and the record ID specified as “record D” for the record D. The update log generating unit 15b then appends an empty “data area” to the “log management area” thus generated, to generates an update log.

The update applying unit 15c is a processing unit that operates, upon receiving a response of receiving the update log transmitted by the update log transmitting unit 14c from each of the servers, the database based on the update log generated by the update log generating unit 15b.

For example, when the update log is specified as “process type=add, record ID=record B, user data=XXX”, the update applying unit 15c generates a new record B storing therein XXX in the data area in the database stored in the storage unit 12. When the update log is specified as “process type=update, record ID=record C, user data=YYY”, the update applying unit 15c updates the data area of the record C stored in the database in the storage unit 12 to YYY. When the update log is specified as “process type=delete, record ID=record D, user data=(blank)”, the update applying unit 15c deletes the data area associated with the record D.

Referring back to FIG. 2, the commit responding unit 15d receives a response of receiving the update log from each of the servers, and, when the update applying unit 15c completes updating a record, transmits a commit response corresponding to a commit request received thereby to the client. When the client receives the commit response thus transmitted, the transaction executed by the client is ended.

Configuration of Standby Server

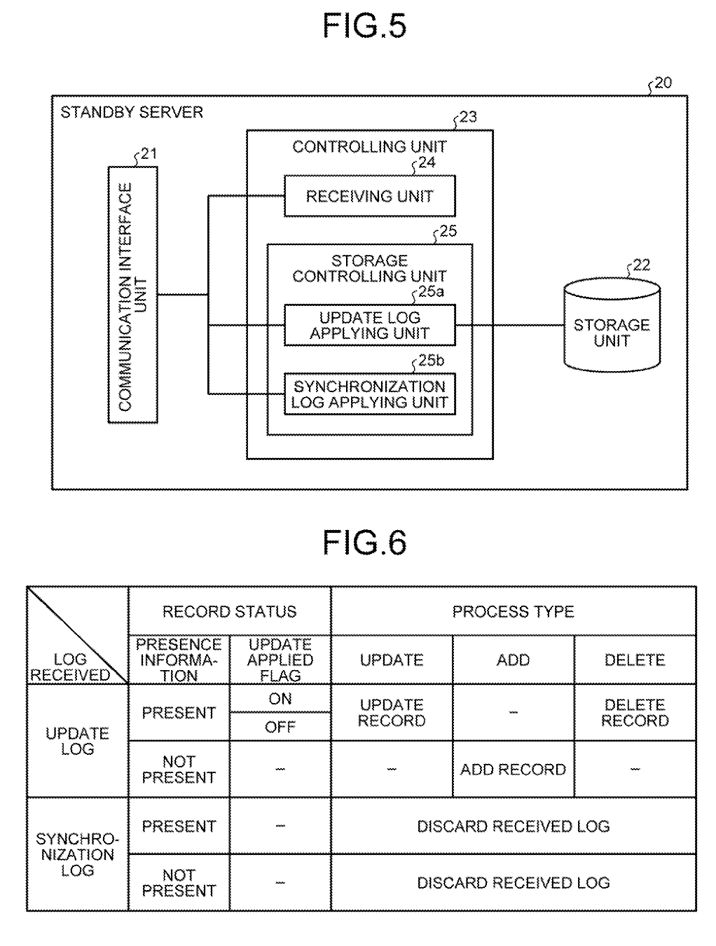

FIG. 5 is a functional block diagram illustrating a configuration of a standby server according to the second embodiment. As illustrated in FIG. 5, the standby server 20 includes a communication interface unit 21, a storage unit 22, and a controlling unit 23. As for the standby server 20 as well, processing units included in the standby server 20 are not limited to those illustrated in FIG. 2, and the standby server 20 may also include a displaying unit such as a display and an input unit such as a keyboard, in the same manner as in the active server 10.

The communication interface unit 21 is a communication module such as a network interface card, and controls communications with other devices. For example, the communication interface unit 21 receives a synchronization log or an update log from the active server 10, and transmits a response of receipt to the active server 10.

The storage unit 22 is a storage device such as a semiconductor memory element or a hard disk for maintaining a database that is mirrored with the storage unit 12 included in the active server. Because the data structure of a record included in the database maintained on the storage unit 22 is same as the structure illustrated in FIG. 3, a detailed explanation thereof is omitted herein.

The controlling unit 23 is an electrical circuit, such as an integrated circuit, e.g., a FPGA or a CPU, that includes a receiving unit 24 and a storage controlling unit 25, and executes the database synchronizing process using these units. The controlling unit 23 includes software for realizing clustering and hardware for realizing clustering. The controlling unit 23 also performs, when the standby server 20 is promoted to the active server, the same operations as those that are caused by the controlling unit 13 to be performed by each of the processing units included in the active server 10 illustrated in FIG. 2.

The receiving unit 24 is a processing unit for receiving a synchronization log or an update log from the active server 10. For example, the receiving unit 24 receives a synchronization log or an update transmitted by the active server 10 over multicast via the communication interface unit 21, and outputs each of the logs thus received to the storage controlling unit 25. The receiving unit 24 transmits, when an update log or a synchronization log is received from the active server 10, a response of receipt to the active server 10 via the communication interface unit 21. Alternatively, the response may be transmitted by other processing unit such as an update log applying unit 25a or a synchronization log applying unit 25b.

The storage controlling unit 25 is a processing unit for generating a record in the storage unit 22 based on a log received by the receiving unit 24 depending on the type of the log thus received and the status of a record in the database identified by the log thus received. The storage controlling unit 25 includes the update log applying unit 25a and the synchronization log applying unit 25b, and executes synchronizing process using these units.

The update log applying unit 25a is a processing unit where the storage unit 22 generates a record in the database based on a received update log. An example of the determination criteria by which the update log applying unit 25a determines whether an update log may be applied will now be explained. FIG. 6 is a schematic illustrating the example of the criteria allowing the standby server to determine whether an update log or a synchronization log may be applied. The determination criteria will be explained using the example of an update log, among the logs illustrated in FIG. 6. The determination criteria illustrated in FIG. 6 may be stored in an internal memory, for example, included in the controlling unit 23 and referred by each of the applying units, or may be implemented as a computer program, for example.

In FIG. 6, an “update log”, which is a type of a log received, is associated with “record status” and “process type”. The “record status” corresponds to the management area included in the exemplary data structure of the record illustrated in FIG. 3, and the “process type” corresponds to the log management area illustrated in FIG. 4. In FIG. 6, the criteria includes “log received”, “record status (presence information, update applied flag)”, and “process type (update, add, delete)”. To these items, “update log”, “present”, “ON”, “update record”, “-”, and “delete record” are respectively associated. “Update log”, “present”, “OFF”, “update record”, “-”, and “delete record” are also respectively associated. To the “log received”, the “record status (presence information, update applied flag)”, and the “process type (update, add, delete)”, “update log”, “not present”, “-”, “-”, “add record”, and “-” are also respectively associated. The symbol “-” indicated herein means that there is no corresponding criterion.

Therefore, upon receiving an update log having the log type specified as “update log”, the process type specified “update”, and the record ID specified as “001”, the update log applying unit 25a retrieves a record corresponding to the record ID=001 from the storage unit 22. The update log applying unit 25a then refers to the “update applied flag” specified in the record corresponding to the record ID=001 obtained by the retrieval. If the “update applied flag” is “ON”, the update log applying unit 25a determines that the log matches the criteria “received log=update log, record status (presence information=present, update applied flag=ON), process type=update”, illustrated in FIG. 6. The update log applying unit 25a then stores the “user data” stored in the data area specified in the update log thus received in the data area at the record ID=001 to update the record at the record ID=001.

Similarly, if the “update applied flag” is “OFF”, the update log applying unit 25a determines that the received log corresponds to “received log=update log, record status (presence information=present, update applied flag=OFF), process type=update” illustrated in FIG. 6. The update log applying unit 25a then stores the “user data” stored in the data area specified in the update log thus received in the data area at the record ID=001 to update the record at the record ID=001. At this time, the update log applying unit 25a changes the update applied flag in the management area at the record ID=001 from “OFF” to “ON”.

When the update log applying unit 25a receives an update log having the log type specified as “update log”, the process type specified as “delete”, and the record ID specified as “001”, the update log applying unit 25a retrieves the record corresponding to the record ID=001 from the storage unit 22. The update log applying unit 25a then refers to the “presence information” and the “update applied flag” in the record corresponding to the record ID=001 obtained by the retrieval.

If the “presence information” is “present” and the “update applied flag” is “ON” at the record ID=001, the update log applying unit 25a determines that the received log corresponds to “received log=update log, record status (presence information=present, update applied flag=ON), process type=delete” illustrated in FIG. 6. The update log applying unit 25a then deletes the “data area” associated with the record ID=001.

Similarly, if the “presence information” is “present” and the “update applied flag” is “OFF” at the record ID=001, the update log applying unit 25a determines that the received log corresponds to “received log=update log, record status (presence information=present, update applied flag=OFF), process type=delete” illustrated in FIG. 6. The update log applying unit 25a then deletes the “data area” associated with the record ID=001. At this time, the update log applying unit 25a changes the update applied flag in the management area at the record ID=001 from “OFF” to “ON”. The update log applying unit 25a may also delete the record itself at the record ID=001.

It is assumed that the update log applying unit 25a receives an update log having the log type specified as “update log”, the process type specified as “add”, and the record ID specified as “011”. In this example, the update log applying unit 25a extracts the “user data” stored in the data area of the update log. The update log applying unit 25a sets the “update applied flag” associated with the record ID=011 to “ON”, and changes the “record information” to “present”. The update log applying unit 25a stores the “user data” extracted from the update log in the “data area” associated with the record ID. In this manner, the update log applying unit 25a generates a new record that is a new data area in the database maintained on the storage unit 22.

The synchronization log applying unit 25b is a processing unit where the storage unit 22 generates a record in the database based on a received synchronization log. An example of the determination criteria by which the synchronization log applying unit 25b determines whether a synchronization log may be applied will now be explained with reference to FIG. 6. The criteria illustrated in FIG. 6 includes “log received”, “record status (presence information, update applied flag)”, and “process type (update, add, delete)”. To these items, “synchronization log”, “present”, “-”, and “discard received log”, and “synchronization log”, “not present”, “-”, and “discard received log” are respectively associated. The symbol “-” indicated herein means that there is no corresponding criterion. In other words, when the synchronization log applying unit 25b receives a synchronization log from the active server 10, the synchronization log applying unit 25b discards the synchronization log without applying the log to the storage unit 22, regardless of the status of the record.

Configuration of Additional Server

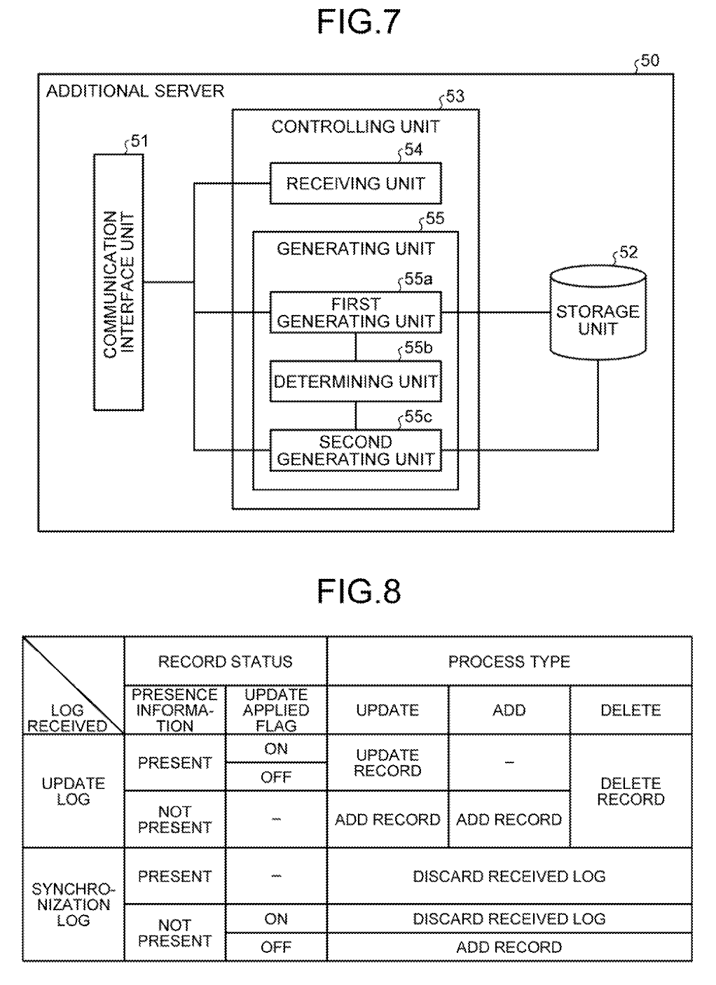

FIG. 7 is a functional block diagram illustrating a configuration of the additional server according to the second embodiment. As illustrated in FIG. 7, the additional server 50 includes a communication interface unit 51, a storage unit 52, and a controlling unit 53. As for the additional server 50 as well, processing units included in the additional server 50 are not limited to those illustrated in FIG. 2, and the additional server 50 may also include a displaying unit such as a display and an input unit such as a keyboard, in the same manner as in the active server 10.

The communication interface unit 51 is a communication module such as a network interface card, and controls communications with other devices. For example, the communication interface unit 51 receives a synchronization log or an update log from the active server 10, and transmits a response of receipt to the active server 10.

The storage unit 52 is a storage device such as a semiconductor memory element or a hard disk, and has no data or record at the time of being added to the cluster system 5. Because the data structure of the record included in the database generated in the storage unit 22 is same as the structure illustrated in FIG. 3, a detailed explanation thereof is omitted herein.

The controlling unit 53 is an electrical circuit, such as an integrated circuit, e.g., a FPGA or a CPU, that includes a receiving unit 54 and a generating unit 55, and executes the database synchronizing process using these units. The controlling unit 53 includes software for realizing clustering and hardware for realizing clustering. The controlling unit 53 also executes, when the additional server 50 is promoted to the active server, the same operation as those that are caused by the controlling unit 13 to be performed by each of the processing units included in the active server 10 illustrated in FIG. 2. The controlling unit 53 also performs, when the additional server 50 becomes a standby server, the same operation as those that are caused by the controlling unit 23 to be performed by each of the processing units included in the standby server 20 illustrated in FIG. 5.

The receiving unit 54 is a processing unit for receiving a synchronization log or an update log from the active server 10. For example, the receiving unit 54 receives a synchronization log or an update transmitted by the active server 10 over multicast via the communication interface unit 51, and outputs each of the logs thus received to the generating unit 55. The receiving unit 54 also transmits, when an update log or a synchronization log is received from the active server 10, a response of receipt to the active server 10 via the communication interface unit 51. Alternatively, the response transmitted by the receiving unit 54 may be transmitted by other processing unit such as a first generating unit 55a or a determining unit 55b.

The generating unit 55 is a processing unit for generating a record in the storage unit 52 based on a log received by the receiving unit 54 depending on the type of the log thus received and the status of a record included in the database identified by the log thus received. The generating unit 55 includes the first generating unit 55a, the determining unit 55b, and a second generating unit 55c, and executes such a process using these units.

An example of the determination criteria by which each of the processing units included in the generating unit 55 determines whether a log received may be applied will be explained. FIG. 8 is a schematic illustrating an example of criteria allowing the additional server to determine whether an update log and a synchronization log may be applied. The determination criteria illustrated in FIG. 8 may be stored in an internal memory, for example, included in the controlling unit 53 and referred by each of the processing units, or may be implemented as a computer program, for example.

In FIG. 8, each of the “update log” and the “synchronization log”, which are types of a log received, is associated with “record status” and “process type”. The “record status” corresponds to the management area in the exemplary data structure of the record illustrated in FIG. 3, and the “process type” corresponds to the log management area illustrated in FIG. 4. In FIG. 8, the criteria includes “log received”, “record status (presence information, update applied flag)”, and “process type (update, add, delete)”. To these items, “update log”, “present”, “ON”, “update record”, “-”, and “delete record” are respectively associated. “Update log”, “present”, “OFF”, “update record”, “-”, and “delete record” are also respectively associated. “Update log”, “not present”, “-”, “add record”, “add record”, and “delete record” are also associated to the “log received”, the “record status (the presence information, update applied flag)”, and the “process type (update, add, delete)”.

Similarly, in FIG. 8, “synchronization log”, “present”, “-”, and “discard received log” are respectively associated to the “log received”, the “record status (presence information, update applied flag)”, and the “process type (update, add, delete)”. In addition, “synchronization log”, “not present”, “ON”, and “discard received log”, and “synchronization log”, “not present”, “OFF”, and “add record” are also respectively associated to the “log received”, the “record status (presence information, update applied flag)”, and the “process type (update, add, delete)”. The symbol “-” indicated herein means that there is no corresponding criterion.

The first generating unit 55a generates, when an update log is received from the active server 10, a record based on the update log thus received in the storage unit 52. For example, upon receiving an update log having the log type specified as “update log”, the process type specified as “update”, and the record ID specified as “100”, the first generating unit 55a retrieves a record corresponding to the record ID=100 from the storage unit 52. The first generating unit 55a then refers to the “presence information” specified in the record corresponding to the record ID=100 and obtained by the retrieval.

If the “presence information” at the record ID=100 is “present”, the first generating unit 55a refers to the “update applied flag” in the record corresponding to the record ID=100. If the “update applied flag” is “ON”, the first generating unit 55a determines that the update log corresponds to “received log=update log, record status (presence information=present, update applied flag=ON), process type=update” illustrated in FIG. 8. The first generating unit 55a then stores the “user data” stored in the data area specified in the update log thus received in the data area at the record ID=100 to update the record at the record ID=100.

Similarly, if the “update applied flag” is “OFF”, the first generating unit 55a determines that the update log corresponds to the criteria “received log=update log, record status (presence information=present, update applied flag=OFF), process type=update” illustrated in FIG. 8. The first generating unit 55a then stores the “user data” stored in the data area specified in the update log thus received in the data area at the record ID=100 to update the record at the record ID=100. At this time, the first generating unit 55a changes the update applied flag in the management area at the record ID=100 from “OFF” to “ON”.

Contrarily, if the “presence information” at the record ID=100 is “not present”, the first generating unit 55a refers to the “update applied flag” in the record corresponding to the record ID=100. When the “update applied flag” is “ON”, the first generating unit 55a determines that the log corresponds to “received log=update log, record status (presence information=not present, update applied flag=ON), process type=update” illustrated in FIG. 8. The first generating unit 55a then stores the “user data” stored in the data area specified in the update log thus received in the data area at the record ID=100 to update the record at the record ID=100.

Similarly, if the “update applied flag” is “OFF”, the first generating unit 55a determines that the log corresponds to “received log=update log, record status (presence information=not present, update applied flag=OFF), process type=update” illustrated in FIG. 8. The first generating unit 55a then stores the “user data” stored in the data area specified in the update log thus received in the data area at the record ID=100 to update the record at the record ID=100. At this time, the first generating unit 55a changes the update applied flag in the management area at the record ID=100 from “OFF” to “ON”.

If an update log having the log type specified as “update log”, the process type specified as “add”, and the record ID specified as “101” is received, the first generating unit 55a retrieves the record corresponding to the record ID=101 from the storage unit 52. The first generating unit 55a then refers to the “presence information” in the record corresponding to the record ID=101 and obtained by the retrieval.

If the “presence information” at the record ID=101 is “not present”, the first generating unit 55a refers to the “update applied flag” in the record corresponding to the record ID=101. If the “update applied flag” is “OFF”, the first generating unit 55a determines that the log corresponds to “received log=update log, record status (presence information=not present, update applied flag=OFF), process type=add” illustrated in FIG. 8. The first generating unit 55a then extracts the “user data” stored in the data area specified in the update log. The first generating unit 55a then sets the “update applied flag” associated with the record ID=101 to “ON”, and changes the “record information” to “present”. The first generating unit 55a then stores the “user data” extracted from the update log in the data area associated with the record ID. In this manner, the first generating unit 55a generates a new record in the database maintained on the storage unit 52.

On the contrary, if the “update applied flag” at the record ID=101 is “ON”, the first generating unit 55a determines that the log corresponds to “received log=update log, record status (presence information=not present, update applied flag=ON), process type=add” illustrated in FIG. 8. In this case as well, the first generating unit 55a generates a new record in the manner described above.

If an update log having the log type specified as “update log”, the process type specified as “delete”, and the record ID specified as “102” is received, the first generating unit 55a deletes the “data area” corresponding to the record ID=101 regardless of the “presence information” and the “update applied flag”. However, if the “update applied flag” is “OFF”, the first generating unit 55a changes the “update applied flag” to “ON” upon deleting the “data area”.

If a synchronization log is received from the active server 10, the determining unit 55b determines if a record has already been generated based on an update log in the storage unit 52 at the position of a record identified by the synchronization log. If the determining unit 55b determines that the record has already been generated, the second generating unit 55c discards the synchronization log. If the determining unit 55b determines that the record has not been generated, the second generating unit 55c generates a record in the storage unit 52 based on the synchronization log.

For example, it is assumed that the determining unit 55b receives a “synchronization log” with a record ID “200”. It is also assumed that the determining unit 55b retrieves the record corresponding to the record ID=200 from the storage unit 52, and the “record information” specified in the “record status” in the record thus retrieved is “present”. In this situation, the second generating unit 55c refers to the “update applied flag” specified in the record corresponding to the record ID=200 obtained by the retrieval. If the “update applied flag” is “ON”, the second generating unit 55c determines that the log corresponds to “received log=synchronization log, record status (presence information=present, update applied flag=ON)” illustrated in FIG. 8. As a result, the second generating unit 55c discards the synchronization log thus received regardless of the process type.

Similarly, if the “update applied flag” is “OFF”, the determining unit 55b determines that the log corresponds to “received log=synchronization log, record status (presence information=present, update applied flag=OFF)” illustrated in FIG. 8. As a result, the second generating unit 55c discards the synchronization log thus received regardless of the process type.

It is assumed that the determining unit 55b retrieves the record corresponding to the record ID=200 from the storage unit 52, and the “record information” specified in the “record status” in the record thus retrieved is “not present”. In other words, the user data in the record is deleted. In this situation, the determining unit 55b refers to the “update applied flag” in the record corresponding to the record ID=200 obtained by the retrieval. If the “update applied flag” is “ON”, the determining unit 55b determines that the log corresponds to “received log=synchronization log, record status (presence information=not present, update applied flag=0N)” illustrated in FIG. 8. As a result, the second generating unit 55c discards the synchronization log thus received regardless of the process type.

If the “update applied flag” is “OFF”, the determining unit 55b determines that the log corresponds to “received log=synchronization log, record status (presence information=not present, update applied flag=OFF) illustrated in FIG. 8. As a result, the second generating unit 55c applies the synchronization log thus received to the database maintained on the storage unit 52. In other words, the second generating unit 55c extracts the “user data” stored in the data area of the synchronization log. The second generating unit 55c then changes the “update applied flag” associated with the record ID=200 to “ON”, and changes the “record information” to “present”. The second generating unit 55c stores the user data extracted from the synchronization log in the “data area” associated with the record ID=200. In this manner, the second generating unit 55c generates a record that is mirrored with the active server 10 in the database maintained on the storage unit 52.

Processes

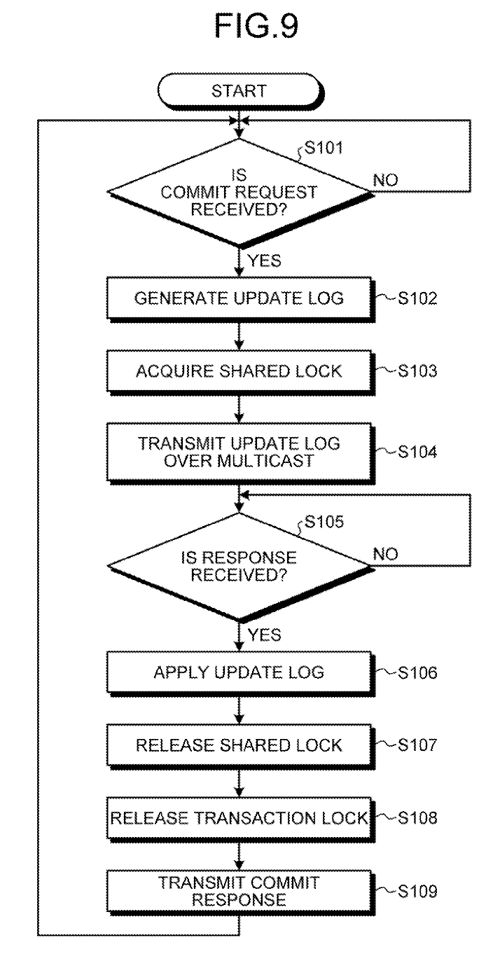

Processes performed by each of the servers will now be explained with reference to FIGS. 9 to 13. Processes performed by the active server 10, a process performed by the standby server 20, and a process performed by the additional server 50 will be explained. The updating process performed by the active server 10 is executed at any time when a record is updated, regardless of the synchronizing process being executed. The synchronizing process is executed when the synchronization of the DB is initiated regardless of the updating process being executed. In other words, the active server 10 executes the updating process and the synchronizing process in parallel.

Update Log Transmitting Process Performed by Active Server

FIG. 9 is a flowchart illustrating the update log transmitting process performed by the active server according to the second embodiment. As illustrated in FIG. 9, if the commit request receiving unit 15a receives a commit request (YES at S101), the update log generating unit 15b generates an update log based on the commit request (S102).

The record updating unit 15 then acquires a shared lock using the concurrency controlling unit 14a, to acquire a lock to an operation unit of the table (S103). The update log transmitting unit 14c transmits the update log generated by the update log generating unit 15b to each of the standby servers and the additional server 50 over multicast (S104).

If a response of receipt is received from each of the servers (YES at S105), the update applying unit 15c applies the update log to the database in the storage unit (S106). The record updating unit 15 then releases the shared lock using the concurrency controlling unit 14a (S107). The concurrency controlling unit 14a also releases the transaction lock (S108). The commit responding unit 15d then transmits a commit response to the client that has requested update of the record (S109). The system control then returns to S101, and every time a commit request is received, the process described above is executed.

A transaction lock herein means a lock that is acquired to prevent inconsistency caused by a plurality of transactions concurrently updating the same record, for example. The transaction lock is acquired when a transaction is initiated, and the transaction lock is released upon processing the commitment that is at an end of the transaction.

Synchronization Log Transmitting Process Performed by Active Server

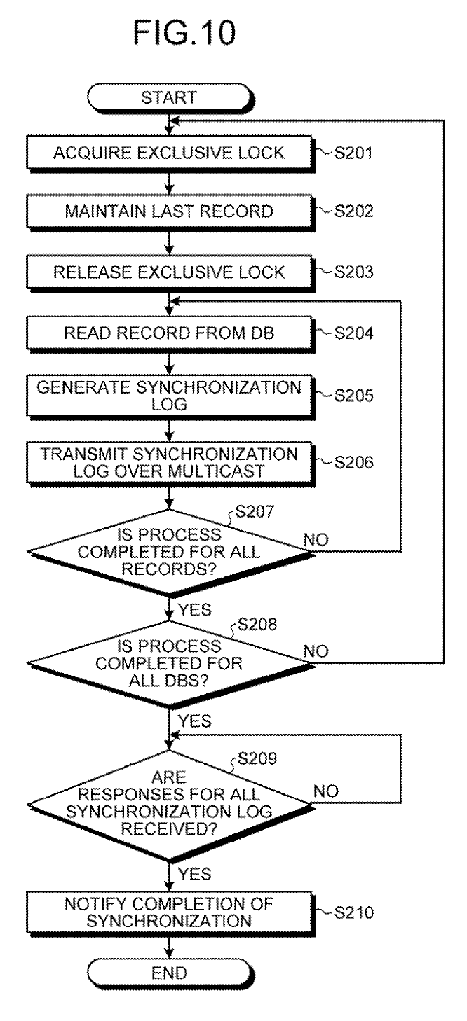

FIG. 10 is a flowchart illustrating a synchronization log transmitting process performed by the active server according to the second embodiment.

As illustrated in FIG. 10, the synchronization log transmitting unit 14b acquires an exclusive lock using the concurrency controlling unit 14a (S201), and prevents the record from being read until the updating process is completed. The synchronization log transmitting unit 14b then refers to the database in the storage unit 12, and maintains the information about the last record to be synchronized (S202). For example, the synchronization log transmitting unit 14b may maintain the record ID of the last record included in the database stored in the storage unit 12, or may maintain a result of counting the number of the records.

The synchronization log transmitting unit 14b releases the exclusive lock using the concurrency controlling unit 14a (S203), reads a record from the database stored in the storage unit 12 (S204), and generates a synchronization log based on the record thus read (S205). For example, the synchronization log transmitting unit 14b reads records from the one located at the head of the database maintained on the storage unit 12.

The synchronization log transmitting unit 14b then transmits the synchronization log thus generated to each of the standby servers and the additional server 50 over multicast (S206). If there is any record to be synchronized and not transmitted yet (NO at S207), the synchronization log transmitting unit 14b returns to S204 and repeats the subsequent steps.

If the transmission is completed for all of the records to be synchronized (YES at S207), the synchronization log transmitting unit 14b determines if the transmission of the synchronization log has been completed for all of the databases that are to be synchronized (S208).

If there is any database for which a synchronization log has not been transmitted (NO at S208), the synchronization log transmitting unit 14b returns to S201 and repeats the subsequent steps. On the contrary, if the transmission of the synchronization log has been completed for all of the databases to be synchronized (YES at S208), the synchronization log transmitting unit 14b determines if responses indicating that all of the synchronization logs thus transmitted have been received from all of the destination servers (S209).

If responses corresponding to all of the synchronization logs have been received from all of the destination servers (YES at S209), the synchronization log transmitting unit 14b ends the database synchronizing process by transmitting a notification of synchronization completion to the terminal of the administrator, or outputting such notification onto a display unit (S210).

Process Performed by Standby Server

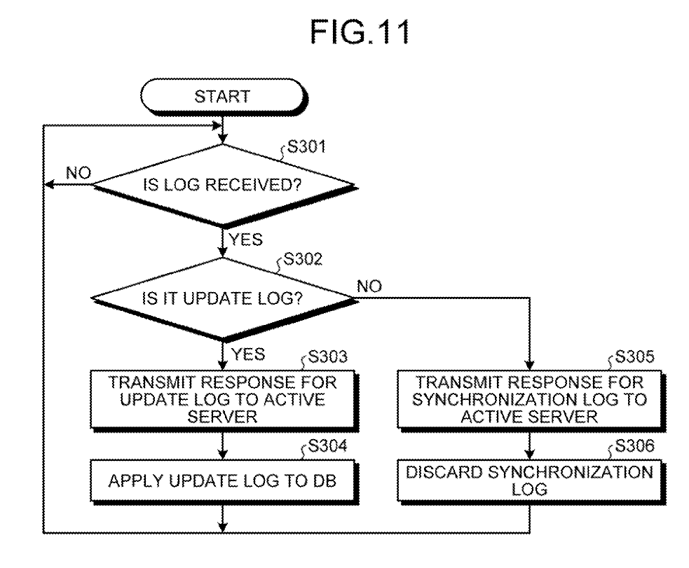

FIG. 11 is a flowchart illustrating the process performed by the standby server according to the second embodiment. The standby server 20 performs the process illustrated in FIG. 11 every time a log is received from the active server 10.

As illustrated in FIG. 11, if the receiving unit 24 receives a log from the active server 10 (YES at S301), the storage controlling unit 25 refers to the log management area of the log thus received to determine if the log thus received is an update log (5302).

If the storage controlling unit 25 determines that the log is an update log (YES at S302), the update log applying unit 25a transmits a response of receiving the update log to the active server 10 (S303). The update log applying unit 25a then applies the update log to the database maintained on the storage unit 22 following the application determination criteria illustrated in FIG. 6 (S304).

On the contrary, if the storage controlling unit 25 determines that the log is not an update log, in other words, that the log is a synchronization log (NO at S302), the synchronization log applying unit 25b transmits a response of receiving the synchronization log to the active server 10 (S305). The synchronization log applying unit 25b discards the synchronization log following the application determination criteria illustrated in FIG. 6 (S306). After S304 or S306 is executed, S301 and the subsequent steps are repeated.

Process Performed by Additional Server

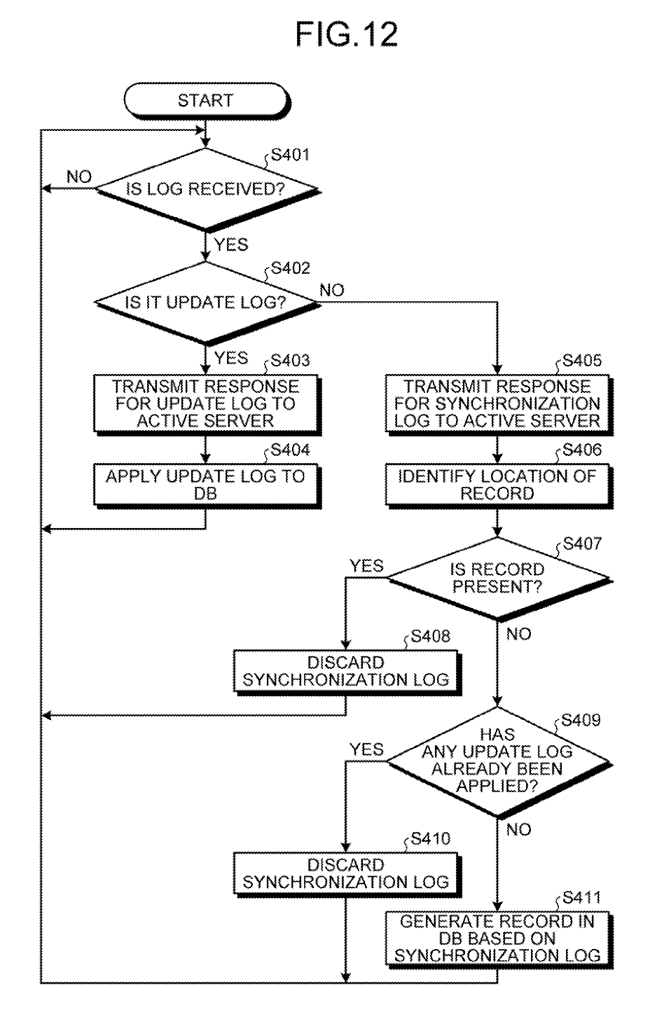

FIG. 12 is a flowchart illustrating a process performed by the additional server according to the second embodiment. The additional server 50 performs the process illustrated in FIG. 12 every time a log is received from the active server 10.

As illustrated in FIG. 12, if the receiving unit 54 receives a log from the active server 10 (YES at S401), the generating unit 55 refers to the log management area specified in the log thus received to determine if the log thus received is an update log (S402).

If the generating unit 55 determines that the log is an update log (YES at S402), the first generating unit 55a or the receiving unit 54 transmits a response of receiving the update log to the active server 10 (S403). The first generating unit 55a then applies the update log to the database maintained on the storage unit 52 following the application determination criteria illustrated in FIG. 8 (S404). The system control then returns to S401, and repeats the subsequent steps.

On the contrary, if the generating unit 55 determines that the log is not an update log, in other words, that the log is a synchronization log (NO at S402), the determining unit 55b or the receiving unit 54 transmits a response of receiving the synchronization log to the active server 10 (S405).

The determining unit 55b then refers to the record ID specified in the log management area in the synchronization log thus received to identify the location of the record to which the synchronization log is to be applied (S406). The determining unit 55b then refers to the record information in the management area of the record thus identified to determine if the record is present, in other words, the data area is present (S407). If the determining unit 55b determines that the record is present, in other words, the data area is present (YES at S407), the second generating unit 55c discards the synchronization log thus received (S408), returns to S401, and repeats the subsequent steps. In other words, in this situation, the additional server 50 determines that an update log has been applied to the position of the record, and discards the synchronization log.

On the contrary, if the determining unit 55b determines that the record is not present, in other words, the data area is not present (NO at S407), the determining unit 55b refers to the update applied flag in the management area to determine if the update log has been applied (S409).

If the determining unit 55b determines that the update log has been applied (YES at S409), the second generating unit 55c discards the synchronization log thus received (S410), returns to S401, and repeats the subsequent steps. On the contrary, if the determining unit 55b determines that the update log has not been applied (NO at S409), the second generating unit 55c generates a record in the database maintained on the storage unit 52 based on the synchronization log thus received (S411), returns to S401, and repeats the subsequent steps.

As described above, according to the second embodiment, the synchronizing process can be executed without controlling the order for applying differences between record data being copied and record data being updated, and the synchronization of the record data can be achieved in different servers without interrupting business applications or the server themselves. Furthermore, because completion of the synchronization depends on the number of records, that is, the number of synchronization logs, the synchronizing process can be completed regardless of the update logs. Furthermore, because no area is used for storing the update logs in each of the servers, no estimation of the storage area is used, thus reducing the workload of the administrator. Furthermore, because a large capacity of the memory is not used, a cost reduction can be achieved.

Furthermore, because the update log and the synchronization log can be processed in parallel even during the synchronizing process, running applications are impacted less. Because the mutual exclusion between the transmission of an update log and the transmission of a synchronization log is controlled using the exclusive lock at the time the synchronizing process is initiated, even if a record is added, omission of a record transmission can be prevented. Therefore, no operation system (OS) resources, such as a CPU or a memory, in the active system are consumed in log application controlling processes. Thus, an impact to the performance of running applications can be reduced.

Furthermore, because the active server 10 simply transmits an update log to each of the standby servers and the additional server 50 and the active server 10 does not execute any record updating process for each of the destination servers, the processing load can be reduced. Furthermore, the active server 10 starts the process of transmitting the synchronization log for the next record when a response of receiving a synchronization log transmitted is received from each of the servers. Therefore, the time for transmitting all of the synchronization logs to the additional server 50 can be reduced compared with the conventional technologies. As a result, the time for synchronizing process can be reduced compared with the conventional technologies.

### [c] Third Embodiment

Some embodiments of the present invention are as explained above. However, the present invention may be implemented in various different embodiments other than those described above. Therefore, different embodiments of the present invention will now be explained.

Servers to be Synchronized

In the examples explained in the embodiments above, a first server corresponds to the active server 10, and a second server corresponds to the additional server 50. However, the present invention is not limited thereto. For example, other server that is synchronized with the active server 10 may be used as the first server, and one of the standby servers in the cluster system 5 in which a DB is restructured in a maintenance, for example, may be used as the second server.

Log Application Conditions

For example, the conditions for applying a log to the standby server 20 illustrated in FIG. 6 or the conditions for applying a log to the additional server 50 illustrated in FIG. 8 may be modified optionally. For example, a condition such as “add a record if any update log is not applied after waiting for 30 seconds from the receipt” may be added to a synchronization log “received log=synchronization log, presence information=not present, update applied flag=OFF”. To explain using an example, if an update log is applied to a record generated by a synchronization log, a writing process will be executed twice to the same record. However, the condition mentioned above causes application of the synchronization log to be withheld for 30 seconds after receipt of the synchronization log. If an update log is then received within the 30 seconds, only the update log is applied. In this manner, it is possible to reduce the number of writing processes executed to the same record, which could occur when an update log is received within a short interval after a synchronization log is received.

System

Among those processes explained in the embodiments, the whole or a part of the processes explained to be executed automatically may also be executed manually. Furthermore, the whole or a part of the processes explained to be performed manually may be performed automatically by known methods. In addition, processing or controlling procedures, specific names, information including various types of data and parameters may be modified in any manner unless specified otherwise.

Furthermore, each of the elements of the devices illustrated in the drawings is merely a depiction of concepts or functionality, and does not necessarily configured physically in the manner illustrated in the drawings. In other words, specific configurations in which each of the devices is distributed or integrated are not limited to those illustrated in the drawings. More specifically, the whole or a part of the devices may be distributed or integrated functionally or physically in any units depending on various loads or utilization. The whole or a part of the processing functions executed in each of the devices may be realized as a CPU and a computer program parsed and executed by the CPU, or realized as hardware using wired logics.

Computer Program

Various processes explained in the embodiments may be realized by causing a computer system such as a personal computer or a work station to execute a computer program prepared in advance. Therefore, an example of a computer system executing a computer program having the same functions as those explained in the embodiments will be explained below.

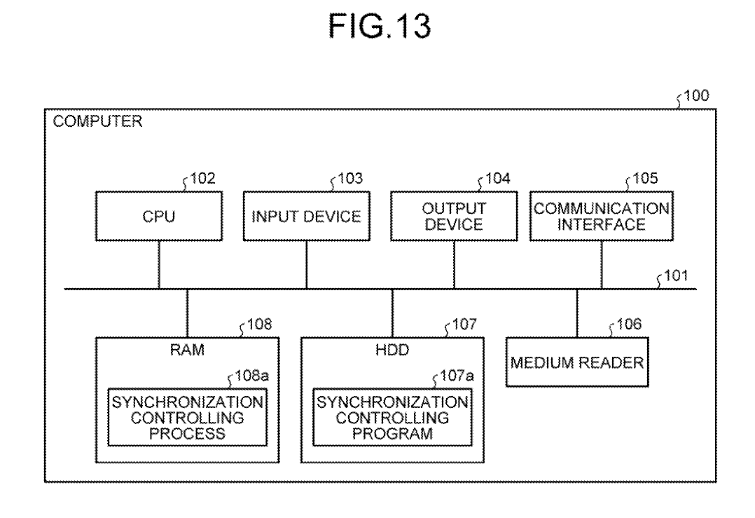

FIG. 13 is a schematic illustrating an example of a hardware configuration of a computer executing a synchronization controlling program. As illustrated in FIG. 13, a computer 100 includes a CPU 102, an input device 103, an output device 104, a communication interface 105, a medium reader 106, a hard disk drive (HDD) 107, and a random access memory (RAM) 108. Furthermore, each of the units illustrated in FIG. 13 are connected via a bus 101.

The input device 103 is a mouse or a keyboard, for example, and the output device 104 is a display, for example. The communication interface 105 is an interface such as network interface card (NIC), for example. The HDD 107 stores therein a synchronization controlling program 107a and a database, for example. The HDD 107 is used as an example of the recording medium. However, various computer programs may be stored in any other computer-readable recording medium such as a read-only memory (ROM), the RAM, or a compact disk read-only memory (CD-ROM), for example, and the computer may be caused to read the computer programs from the recording medium. Furthermore, a storage medium may be deployed in a remote location, and computer may access the storage medium to obtain and to use the computer programs. Furthermore, the computer programs thus obtained may be stored in a local recording medium included in the computer.

The CPU 102 reads the synchronization controlling program 107a and loads the computer program onto the RAM 108 to operate a synchronization controlling process 108a that executes each of the functions explained above with reference to FIG. 2, for example. In other words, the synchronization controlling process 108a executes the same functions as each of the processing units included in the transmission controlling unit 14 and each of the processing units included in the record updating unit 15 illustrated in FIG. 2. Furthermore, the synchronization controlling process 108a may also execute the same processes performed by each of the processing units included in the controlling unit illustrated in FIG. 5 or FIG. 7. In this manner, the computer 100 operates as an information processing system that executes a synchronization controlling method by reading and executing the computer program.

For example, the computer 100 reads the synchronization controlling program from the recording medium using the medium reader 106, and executes the synchronization controlling program thus read to realize the same functions as those according to the embodiments. The computer program mentioned in this other embodiment is not limited to being executed by the computer 100. For example, the present invention may be applied in a similar manner even when the computer program is executed by another computer or another server, or executed in cooperation thereof.

The time to achieve data synchronization for a server that is newly added to a cluster system can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A cluster system comprising:
a first server; and
a second server, wherein
each of the first server and the second server includes a storage unit storing therein client data, information indicating a location of the client data, and information indicating a record status as a record,
the first server further comprises a transmitting unit that transmits a record stored in the storage unit as first information as well as type information indicating the first information to the second server, and, when the record is updated, transmits the record thus updated as second information as well as type information indicating the second information to the second server, and
the second server further comprises a receiving unit that receives the first information or the second information from the first server, and a generating unit that generates a record for the information thus received in the storage unit depending on the type information received by the receiving unit and a status of the record stored in the storage unit and identified by the information thus received.

2. The cluster system according to claim 1, wherein the generating unit included in the second server further comprises:
a first generating unit that generates, when the second information is received from the first server, a record for the second information in the storage unit,
a determining unit that determines, when the first information is received from the first server, whether a record is already generated for the second information at a position of the record in the storage unit that is identified by the first information, and
a second generating unit that discards the first information when it is determined that the record is already generated, and generates a record for the first information in the storage unit when it is determined that the record is not generated.

3. The cluster system according to claim 1, wherein the transmitting unit included in the first server prevents the first information from being read from the storage unit when a record is updated at the timing of reading the record to be transmitted to the second server, determines that number of records included in the storage unit upon completion of updating the record as number of records to be transmitted, and starts reading the records.

4. The cluster system according to claim 1, wherein the transmitting unit included in the first server transmits the second information or the first information to other servers and to the second server included in the cluster system over multicast.

5. A cluster system having a first server and a second server, wherein
the first server includes
a first memory storing therein client data, information indicating a location of the client data, and information indicating a record status as a record;
a first processor coupled to the first memory, wherein the first processor executes a process comprising:
transmitting at which the first server transmits the record stored in the first memory as first information as well as type information indicating the first information to the second server, and, when the record is updated, transmits the record thus updated as second information as well as type information indicating the second information to the second server, and wherein
the second server includes
a second memory storing therein the client data, information indicating a location of the client data, and information indicating the record status as the record;
a second processor coupled to the second memory, wherein the second processor executes a process comprising:
receiving the first information or the second information from the first server; and
generating a record for the information thus received in the second memory depending on the type information received by the receiving and the status of the record stored in the second memory and identified by the information thus received.

6. A synchronization controlling method that is executed by a cluster system including a first server and a second server each of which includes a storage unit storing therein client data, information indicating a location of the client data, and information indicating a record status as a record, the method comprising:
transmitting at which the first server transmits a record stored in the storage unit as first information as well as type information indicating the first information to the second server, and, when the record is updated, transmits the record thus updated as second information as well as type information indicating the second information to the second server;
receiving at which the second server receives the first information or the second information from the first server; and
generating at which the second server generates a record for the information thus received in the storage unit depending on the type information thus received and a status of the record stored in the storage unit and identified by the information thus received.

7. A server comprising:
a receiving unit that receives first information that is information of a record in a storage unit included in a source server and storing therein client data, information indicating a location of the client data, and a record status as a record, as well as type information indicating the first information from the source server, or, when the record in the storage unit is updated, receives second information that is information of the record thus updated and type information indicating the second information from the source server; and
a generating unit that generates a record for the information thus received in a local storage unit included in the server depending on the type information received by the receiving unit, and a status of the record in the storage unit and identified by the information thus received.

8. A server comprising:
a memory; and
a processor coupled to the memory, wherein the processor executes a process comprising:
receiving first information that is information of a record in the memory included in a source server and storing therein client data, information indicating a location of the client data, and a record status as a record, as well as type information indicating the first information from the source server, or, when the record in the memory is updated, receives second information that is information of the record thus updated and type information indicating the second information from the source server; and
generating a record for the information thus received in a local memory included in the server depending on the type information received by the receiving, and a status of the record in the local memory and identified by the information thus received.

9. A non-transitory computer-readable storage medium that stores synchronization controlling program for causing a computer to execute:
receiving first information that is information of a record in a storage unit included in a source server and storing therein client data, information indicating a location of the client data, and a record status as a record, as well as type information indicating the first information from the source server, or, when the record in the storage unit is updated, receiving second information that is information of the record thus updated and type information indicating the second information from the source server; and
generating a record for the information thus received in a local storage unit included in the computer depending on the type information thus received, and a status of the record in the storage unit and identified by the information thus received.
